(19) United States
(12) Patent Application Publication
(10) Pub. No.: US 2011/0015903 A1
(43) Pub. Date: Jan. 20, 2011

(54) Method of Searching for Positions to Place Control Rods with Crack in a Boiling Water Reactor Core

(75) Inventors: Tian-Tzuoh LEE, Taoyuan County (TW); Chung-Hsing Hu, Taoyuan County (TW); Yao-Nan Huang, Taoyuan County (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/138,160

(22) Filed: Jun. 12, 2008

(51) Int. Cl. G06F 7/60; G06F 17/10

(52) U.S. Cl. 703/2

(57) ABSTRACT

Disclosed is a method of searching for positions to place control rods with crack in a boiling water reactor core. When a control rod is broken in a nuclear reactor core, it is determined whether the smallest cold shut-down margin meets the regulations of the laws. Positions meeting the regulations of the laws are found to place control rods that might be broken but are still in operation in the reactor core. After the cold shut-down margins are confirmed, the critical safety is determined to avoid the risk of not being able to shut down the reactor core when urgent shut-down is needed.

### FIELD OF THE INVENTION

The present invention relates to a method for searching for positions to place control rods with crack in a boiling water nuclear reactor core and, more particularly, to a method for searching for positions to place control rods that with crack via calculating cold shut-down margins.

### DESCRIPTION OF THE RELATED ARTS

During the operation of a nuclear reactor core, a control rod might be broken and therefore lose boron carbide, which is used to absorb neutron poison. Thus, the strength of the control rod might be affected. The cold shut-down margin might be inadequate, thus incurring critical safety. In such a case, the nuclear reactor core could not be shut down when urgent shut-down is needed.

Therefore, the present invention is intended to obviate or at least alleviate the problems encountered in prior art.

### SUMMARY OF THE INVENTION

It is the primary objective of the present invention to provide a method of searching for positions to place control rods with crack in a boiling water reactor core.

To achieve the foregoing objective, the method includes steps A to O. At step A, there is provided a SIMULATE-3 standard file for calculating cold shut-down margins. At step B, the SIMULATE-3 standard file is executed to calculate the original cold shut-down margins. The original cold shut-down margins of all of the control rods at all of the burn-up points are recorded in a calculation result abstract file. At step C, the SIMULATE-3 standard file is taken as a reference file. There is extracted the contents of cards at the burn-up points. First and second cards for calculating the cold shut-down margins are disposed of. There is added a third card for indicating a singled-out control rod and a broken control rod. At step D, the singled-out control rod is selected. At most eight control rods around the singled-out control rod are taken as candidates for the broken control rod. At step E, the core multiplication factors of various combinations of the control rods calculated with the SIMULATE-3 code are recorded. At step F, it is determined whether step D is completed at all of the burn-up points, and going to step C if not. At step G, changes in the cold shut-down margins because of the broken control rod are calculated. At step H, changes in the cold shut-down margins because of the broken control rod are recorded. At step I, a broken control rod is selected. It is determined whether the cold shut-down margin of all strongest rods selected meets the regulations of the laws. The process goes to step O if not. At step J, the cold shut-down margin of the singled-out control rod selected at step I is compared with that of the original strongest rod. The process goes to step M if the cold shut-down margin of the singled-out control rod corresponding to the position of the broken control rod is smaller than that of the original strongest rod. Otherwise, the process goes to step K if the channel flow distribution of the core inlet orifices are not quarter core symmetric. The process goes to step L if the channel flow distribution of the core inlet orifices are quarter core symmetric. At step K, there is selected the burn-up point related to the smallest cold shut-down margin selected at step B. There are calculated the cold shut-down margins of all of the control rods based on this burn-up point. Eight control rods with smallest cold shut-down margins are taken as candidates for the singled-out control rod, reselecting the strongest rod. The selected position of the broken control rod is abandoned if the cold shut-down margin of this strongest rod is smaller than required by the laws. Otherwise, the selected position is retained. Then, the process goes to step M. At step L, the strongest rod is reselected via calculating the burn-up point of the control rod with the smallest cold shut-down margin. The cold shut-down margins of all of the control rods are calculated based on this burn-up point. Two control rods with smallest cold shut-down margins are taken as the candidates for the singled-out control rod so that the candidates for the strongest rods selected at step I are in one quarter of the core and that the candidates for the singled-out control rod and the candidates for the broken control rod are in a same phase. The selected position of the broken control rod is abandoned if the cold shut-down margin of this strongest rod is smaller than required by the laws. Otherwise, the selected position is retained. Then, the process goes to step M. At step M, it is determined whether the cold shut-down margin of all strongest rods selected are smaller than that of the original strongest rod. The process returns to step J if the cold shut-down margin of any one of strongest rods is not smaller than that of the original strongest rod. At step N, the result is printed. At step O, the search is terminated.

Other objectives, advantages and features of the present invention will be apparent from the following description referring to the attached drawing.

### BRIEF DESCRIPTIONS OF THE DRAWINGS

The present invention will be described via the detailed illustration of the preferred embodiment referring to the drawing.

FIG. 1 is a flow chart of a method of searching for positions to place control rods with crack in a boiling water reactor core according to the preferred embodiment of the present invention.

### DESCRIPTION OF THE PREFERRED EMBODIMENT

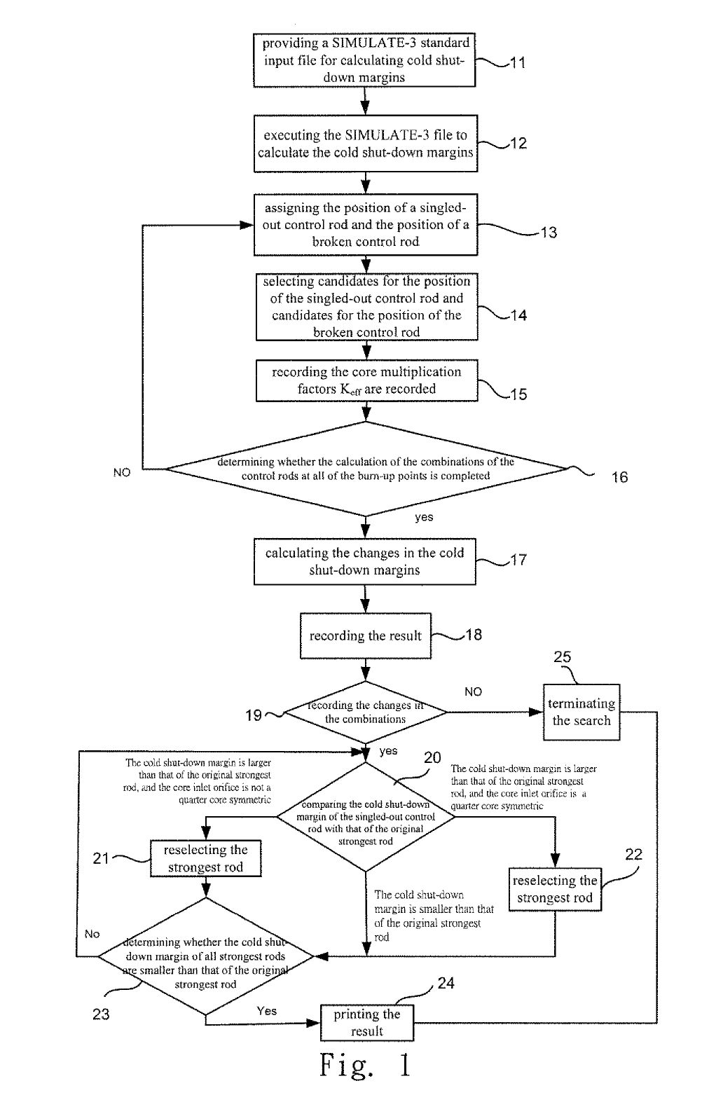

Referring to FIG. 1, there is shown a method of searching for positions to place control rods with crack in a boiling water reactor core according to the preferred embodiment of the present invention. In the operation of the method, it is assumed that when a control rod is broken, four blades on an upper quarter of the length thereof, which includes twelve notches, lose all of its boron carbide. Only one control rod is broken in the entire nuclear reactor core. However, each of the control rods could be broken.

At 11, there is provided SIMULATE-3 standard input file for calculating cold shut-down margins.

At 12, the SIMULATE-3 file is executed to calculate the cold shut-down margins. In a QPANDA mode, the original cold shut-down margins of all of the non-broken control rods are calculated at all of the burn-up points in the entire period. The original cold shut-down margins of all of the control rods at all of the burn-up points are recorded in a calculation result abstract file. The control rod with the smallest original cold shut-down margin is the strongest rod at a certain burn-up point. On the contrary, the control rod with the largest original cold shut-down margin is the weakest rod at a certain burn-up point.

At 13, the position of a singled-out control rod and the position of a broken control rod are assigned. The SIMULATE-3 standard input file is used as a reference file. At different burn-up points, the contents of cards are extracted. A CRD.SDM card and an ITE.SDM card are disposed of, while a CRD.POS card is added. The CRD.POS card assigns the position of the singled-out control rod and the position of the broken control rod. The position of the singled-out control rod is represented by extracting forty-eight notches. The position of the broken control rod is represented by extracting twelve notches,i.e., one quarter of the length.

At 14, candidates for the position of the singled-out control rod and candidates for the position of the broken control rod are selected. At most eight control rods around the position of the singled-out control rod are taken as the candidates. At 13, each of the control rods can be selected as the singled-out control rod. The priority is determined by the original cold shut-down margins of the control rods, from the smallest to the largest.

At 15, the core multiplication factors K_{eff} are recorded. The core multiplication factors K_{eff} of various combinations of the positions of the control rods calculated with the SIMULATE-3 code are recorded.

At 16, it is determined whether the calculation of the combinations of the control rods at all of the burn-up points is completed. If not, the process returns to 13.

At 17, the changes in the cold shut-down margins are calculated. The changes in the cold shut-down margins due to the breach of the control rod are calculated. The calculation is done at two steps. Firstly, the core multiplication factor K_{eff} when the single control rod is completely extracted is subtracted from the core multiplication factor K_{eff} when the entire length of a single control rod is pulled and twelve notches of another control rod are Secondly, the difference is divided by a cold critical target value,

At 18, the result is recorded. The result is sorted, and the changes in the cold shut-down margins due to the breach of the control rod in all of the combinations are recorded. The changes will reduce the original cold shut-down margins of all of the control rods.

At 19, the changes in the combinations are recorded. Based on the result of 18, it is determined whether the strongest rod in the case of the breach of a control rod in the nuclear reactor core meets the regulations of the laws.

At 20, the cold shut-down margin of the singled-out control rod is compared with that of the original strongest rod. If the cold shut-down margin of the singled-out control rod corresponding to the position of the broken control rod is smaller than that of the original strongest rod, the process goes to 23. Otherwise, the singled-out control rod is not the strongest rod, and another round of research for the strongest rod is executed. If the channel flow distribution of the core inlet orifices are not quarter core symmetric, the process goes to 21. Otherwise, the process goes to 22.

At 21, the strongest rod is reselected. The burn-up point of the control rod with the smallest cold shut-down margin is calculated. Based on this burn-up point, the cold shut-down margins of all of the control rods are calculated. Eight control rods with the smallest cold shut-down margins are taken as candidates for the singled-out control rod. The candidates are the strongest rods selected at 21 and are spread in the entire core. The candidates for the broken control rod are determined at 19. The strongest rod is reselected. If the cold shut-down margin of the strongest rod is smaller than required by the laws, the selected position of the broken control rod is abandoned. Otherwise, the selected position is retained, and the process goes to 23.

At 22, the strongest rod is reselected. The burn-up point of the control rod with the smallest cold shut-down margin is calculated. Based on the burn-up point, the cold shut-down margins of all of the control rods are calculated. Two control rods with the smallest cold shut-down margins are taken as candidates for the singled-out control rod. The candidates are the strongest rods selected at 12 and are located in one quarter of the core. The candidates for the singled-out control rod and the candidates for the broken control rod must be located in a same phase. The candidates for the broken control rod are determined at 19. The strongest rod is reselected. If the cold shut-down margin of this strongest rod is smaller than required by the laws, the selected position of the broken control rod is abandoned. Otherwise, the selected position is retained, and the process goes to 23.

At 23, it is determined whether the cold shut-down margin of all strongest rods selected are smaller than that of the original strongest rod. If the cold shut-down margin of any one of strongest rods selected is not smaller than that of the original strongest rod, the process returns to 20.

At 24, the result is printed.

At 25, the search is terminated.

As discussed above, the present invention provides a method of searching for positions to place control rods with crack in a boiling water reactor core. When a control rod is broken in a nuclear reactor core, it is determined whether the smallest cold shut-down margin meets the regulations of the laws. Positions meeting the regulations of the laws are found to place control rods that might be broken but are still in operation in the reactor core. After the cold shut-down margins are confirmed, the critical safety is determined to avoid the risk of not being able to shut down the reactor core when urgent shut-down is needed.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method of searching for positions to place control rods with crack in a boiling water reactor core comprising the steps of:
(A) providing a SIMULATE-3 standard file for calculating cold shut-down margins;
(B) executing the SIMULATE-3 standard file to calculate the original cold shut-down margins, and recording the original cold shut-down margins of all of the control rods at all of the burn-up points in a calculation result abstract file;
(C) taking the SIMULATE-3 standard file as a reference file, extracting the contents of cards at the burn-up points, and disposing of first and second cards for calculating the cold shut-down margins and adding a third card for indicating a singled-out control rod and a broken control rod;
(D) selecting the singled-out control rod, taking at most eight control rods around the singled-out control rod as candidates for the broken control rod;
(E) recording core multiplication factors of various combinations of the positions of the control rods calculated with the SIMULATE-3 code;
(F) determining whether step (D) is completed at all of the burn-up points, and going to step (C) if not;
(G) calculating changes in the cold shut-down margins because of the broken control rod;
(H) recording changes in the cold shut-down margins because of the broken control rod;
(I) selecting a broken control rod, determining whether the cold shut-down margin of all strongest rods selected meets the regulations of the laws, and going to step (O) if not;
(J) comparing the cold shut-down margin of the singled-out control rod selected at step (I) with that of the strongest rod, going to step (M) if the cold shut-down margin of the singled-out control rod corresponding to the position of the broken control rod is smaller than that of the strongest rod, and otherwise going to step (K) if the channel flow distribution of the core inlet orifices are not quarter core symmetric, and going to step (L) if the channel flow distribution of the core inlet orifices are quarter core symmetric;
(K) selecting the burn-up point related to the smallest cold shut-down margin selected at step (B), calculating the cold shut-down margins of all of the control rods based on this burn-up point, taking eight control rods with smallest cold shut-down margins as candidates for the singled-out control rod, reselecting the strongest rod, abandoning the selected position of the broken control rod if the cold shut-down margin of this strongest rod is smaller than required by the laws, and otherwise retaining the selected position, and going to step (M);
(L) reselecting the strongest rod via calculating the burn-up point of the control rod with the smallest cold shut-down margin, calculating the cold shut-down margins of all of the control rods based on this burn-up point, taking two control rods with smallest cold shut-down margins as the candidates for the singled-out control rod so that the candidates for the strongest rods selected at step (I) are in one quarter of the nuclear reactor core and that the candidates for the singled-out control rod and the candidates for the broken control rod are in a same phase, abandoning the selected position of the broken control rod if the cold shut-down margin of this strongest rod is smaller than required by the laws, and otherwise retaining the selected position, and going to step (M);
(M) determining whether the cold shut-down margin of all strongest rods selected are smaller than that of the original strongest rod, and returning to step (J) if the cold shut-down margin of any one of strongest rods selected is not smaller than that of the original strongest rod;
(N) printing the result; and
(O) terminating the search.

2. The method according to claim wherein step (B) comprises the step of calculating the original cold shut-down margins of all of non-broken control rods at all of the burn-up points in a QPANDA mode.

3. The method according to claim 1, wherein step (C) comprises the step of indicating the position of the broken control rod via extracting twelve notches, i.e., a quarter of the length of the control rod.

4. The method according to claim 1, wherein each control rod could be selected as the singled-out control rod at step (C), and the priority is based on the original cold shut-down margins of the control rods.

5. The method according to claim 1, wherein step (G) comprises the steps of:
subtracting the core multiplication factor K_{eff} when the single control rod is completely extracted is from the core multiplication factor K_{eff} when the entire length of a single control rod is pulled and twelve notches of another control rod are pulled; and
dividing the difference by a cold critical target value.

6. The method according to claim 1, wherein the changes obtained at step (H) reduce the original cold shut-down margins of the control rods obtained at step (B).
